(19) United States
(12) Patent Application Publication
(10) Pub. No.: US 2026/0011486 A1
(43) Pub. Date: Jan. 8, 2026

(54) MAGNETIC COMPONENT AND METHOD OF MANUFACTURING

(71) Applicant: TDK Electronics AG, Muenchen (DE)

(72) Inventors: Fabian Beck, Rüttenen (CH); Jan Simecek, Novy Malin (CZ)

(21) Appl. No.: 18/993,215

(22) PCT Filed: Jun. 28, 2023
(86) PCT No.: PCT/EP2023/067707

§ 371 Date: Jan. 10, 2025

(30) Foreign Application Priority Data
Jul. 15, 2022 (DE) 10 2022 117 781.5

(51) Int. Cl. H01F 27/32; H01F 27/24; H01F 41/12

(52) U.S. Cl. CPC H01F 27/325; H01F 27/24; H01F 41/127

(57) ABSTRACT

In an embodiment a magnetic component includes a magnetic core, a coil having a winding wound around the magnetic core, a main magnetic flux path within the magnetic core, and a stray magnetic flux area outside the magnetic core, wherein the stray magnetic flux area is at least partially embedded in or guided by a first material, and wherein the first material is a thermally conductive filler or potting material.

### CROSS-REFERENCE TO RELATED APPLICATIONS

This patent application is a national phase filing under section 371 of PCT/EP2023/067707, filed Jun. 28, 2023, which claims the priority of German patent application no. 102022117781.5, filed Jul. 15, 2022, each of which is incorporated herein by reference in its entirety.

### TECHNICAL FIELD

The present invention refers to magnetic components with improved properties and to methods of manufacturing such components.

### BACKGROUND

Magnetic components such as magnetic coils shall have ideal magnetic and electromagnetic properties. However, physical realizations show a deviation from ideal properties.

From DE 10 2017 114 900 A1 multiphase coupled inductors are known. From U.S. Pat. No. 10,163,563 B2 components with coils fixed in a cavity and comprising additional matter are known. From US 2020/0286667 A1 magnetic component structures with fillers are known.

### SUMMARY

Embodiments provide magnetic components with improved properties. Specifically, it is desired to have magnetic components with improved magnetic, thermal and insulation properties.

The magnetic component comprises a magnetic core and a coil having a winding wound around the magnetic core. The magnetic component further has a main magnetic flux path within the magnetic core and a stray magnetic area outside the magnetic core. The stray magnetic flux area is, however, at least partially embedded in or guided by a first material.

The magnetic component can be a coupled inductor with two or more inductive segments coupled magnetically or electromagnetically to one another.

The magnetic component is based on the idea that in a coupled inductor—especially during operation—the magnetic flux lines essentially are contained within matter, e.g. within a solid magnetic structure, e.g. within the magnetic core.

Additionally, it was found to be beneficial that the magnetic flux outside the magnetic structure, e.g. a stray magnetic flux, is still contained within a predefined material with predefined magnetic and/or thermodynamic properties.

Thus, a magnetic component is provided where the magnetic flux outside a magnetic core is at least partially contained within a specifically dedicated material, the first material, e.g. a magnetic resin.

Then, stray magnetic flux can be concentrated in a specifically dedicated material—the first material—with correspondingly selected magnetic, electromagnetic and thermodynamic properties such as magnetic permeability, electric conductivity and thermal conductivity.

Further, the first material, e.g. a magnetic resin, can also help to conduct unwanted heat due to energy dissipation to an external environment of the magnetically active regions of the component, e.g. to an outer surface, a cooling liquid in which the component is arranged or to an external heat bridge, e.g. an aluminum body.

Additionally the first material can be used for an appropriate electrical insulation system.

It is possible that in the magnetic component the first material is a thermally conductive filler or potting material.

It is possible that the magnetic component is a coupled inductor with two or more inductive segments coupled magnetically or electromagnetically to one another.

It is possible that in the magnetic component the first material has a magnetic permeability μ_1 with 1.5≤μ_1≤26.

It is possible that in the magnetic component the magnetic core has a magnetic permeability μ_2 with 26≤μ_2≤27000.

It is possible that in the magnetic component the first material has a thermal conductivity equal to or larger than 0.5 W/mK.

It is possible that in the magnetic component the first material has an electric resistivity r with r≥10 kV/mm.

It is possible that in the magnetic component the magnetic core comprises an upper magnetic core part and a lower magnetic core part. Further, the upper magnetic core part and the lower magnetic core part form a casing with a front opening and a rear opening.

However, it is possible that the number of constituent parts of the magnetic core is larger than two.

Further, it is possible that the magnetic core is provided as a monolithic part. Thus, the number of constituent parts of the magnetic core can be one, too.

It is possible that in the magnetic component the coil is mounted in the casing.

It is possible that in the magnetic component the coil comprises a first terminal connection and a second terminal connection. Further, the first and second terminal connections extend outwardly from a front side or a front opening of the component.

It is possible that in the magnetic component the first material is arranged around the coil and/or the magnetic core.

It is possible that in the magnetic component the lower or upper magnetic core part comprises a center column for the coil to be at least partially mounted thereon. Further, the center column extends upwardly from a mounting plane of the lower magnetic core part and is shifted from a center of the mounting plane to a front opening.

Further, it is possible that in the magnetic component the magnetic core is built monolithically and comprises a center column for the coil to be at least partially mounted thereon. Then, the center column extends upwardly from a mounting plane of the magnetic core and is shifted from a center of the mounting plane to a front opening.

It is possible that in the magnetic component a surface of the first material is flush with a rear opening.

It is possible that in the magnetic component a portion of the first material projects from a rear opening.

It is possible that the magnetic component further comprises a bobbin mounted on the lower magnetic core part, wherein the coil is wound around the bobbin.

It is possible that in the magnetic component the bobbin comprises or consists of a plastic material.

It is possible that the magnetic component further comprises an insulating paper and/or an insulating film arranged between the coil and an upper magnetic core part.

It is possible that the magnetic component further comprises a thermally conductive interface material between the first material and an upper magnetic core part and/or between the first material and a lower magnetic core part. The thermally conductive interface material has a hardness equal to or smaller than a hardness of the first material or equal to or smaller than a hardness of the upper magnetic core part or equal to or smaller than a hardness of the lower magnetic core part.

It is possible that in the magnetic component the first material at least partially fills up a casing of the component from a rear opening to a front opening.

It is possible that in the magnetic component the first material at least partially fills up a casing from a mounting plane of a lower magnetic core part to an upper magnetic core part.

It is possible that in the magnetic component the magnetic core, a lower magnetic core part and/or an upper magnetic core part comprise(s) or consist(s) of a material selected from a Fe—Si based alloy, a Fe—Ni based alloy, MnZn or a MnZn based alloy, NiZn or a NiZn based alloy.

It is possible that in the magnetic component the first material comprises or consists of a material selected from a thermoset phenolic resin; thermoplastic polyethylene terephthalate, PET; polyamide, PA; polyphenylene sulfide, PPS; and polyetheretherketone, PEEK; PUR, polyurethane, epoxy, a silicon based resin.

It is possible that in the magnetic component a front opening and a rear opening are arranged opposite to each other in two parallel and opposite directions of an expansion stress to reduce the expansion stress acting on an upper magnetic core part and a lower magnetic core part.

It is possible that in the magnetic component the first material does not fully encapsulate an outer surface of an upper magnetic core part and a lower magnetic core part.

A method of manufacturing a magnetic component, e.g. as stated above, comprises the steps of:
providing a mold with a coil mounted therein,
potting the mold with a thermally conductive material to form a first material,
encapsulating at least a portion of the coil,
releasing the first material and the coil from the mold,
combining the first material with a magnetic core. It is possible that
the mold comprises a lower magnetic core part,
combining the first material with the magnetic core comprises combining a lower magnetic core part with an upper magnetic core part,
the first material is arranged or contained between the upper magnetic core part and the lower magnetic core part.

It is possible that the method further comprises
mounting a bobbin on a lower magnetic core part,
winding the coil around the bobbin,
encapsulating a portion of the coil on the bobbin and a lower magnetic core part by the first material.

It is possible that in the method
the mold comprises a lower magnetic core part and an upper magnetic core part, and
combining the first material with the magnetic core comprises combining a lower magnetic core part, an upper magnetic core part and the first material, wherein the first material is arranged or contained between the upper magnetic core part and the lower magnetic core part.

It is possible that the method further comprises arranging a thermally conductive interface material between the coil and the first material.

It is possible that the method further comprises
providing a mold comprising an upper magnetic core part and a lower magnetic core part and a coil mounted in the mold,
potting the mold with a thermally conductive material to form a thermally conductive filler,
encapsulating at least a portion of the coil.

Thus, with the features stated above the first material, e.g. a resin, is utilized to generate a defined magnetic path or for shielding purposes.

Further, the first material, e.g. a resin, is used to thermally fix the casted part, e.g. coupled inductor, to its interface, e.g. an aluminum housing.

Further, the first material, e.g. a resin, allows electrical insulation, e.g. between the coupled coil segments and their environment, e.g. the housing, e.g. an aluminum housing.

### BRIEF DESCRIPTION OF THE DRAWINGS

The basic working principles and details of preferred embodiments are shown in the schematic accompanying figures.

FIG. 1 shows a basic construction variant of the magnetic component; and

FIG. 2 shows the magnetic flux of a basic construction variant of the magnetic component.

### DETAILED DESCRIPTION OF ILLUSTRATIVE EMBODIMENTS

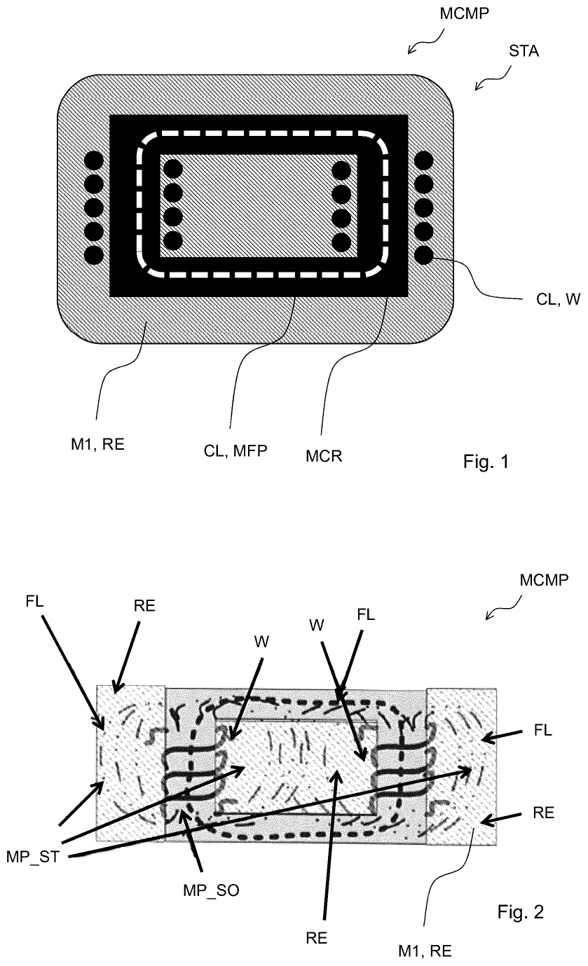

FIG. 1 exemplarily shows a basic construction variant of the magnetic component MCMP. The magnetic component MCMP comprises a magnetic core MCR.

The magnetic core MCR can comprise a topology with a closed loop for the magnetic flux path MFP. The magnetic core can comprise a lower part and an upper part that form together the closed loop.

Further, the magnetic component comprises the first material Mi to guide stray magnetic flux at least partially. The first material can be a resin or a plastic material. The first material can comprise magnetic particles or other magnetic components that are embedded in the first material as a matrix material or that provide-together with the first material-a single phase without phase boundaries.

Further, the magnetic component comprises a coil CL with windings W.

The core MCR and the coil CL can be embedded in the first material.

FIG. 2 shows magnetic flux during operation of a basic construction variant of the magnetic component.

The first material as or in a potting compound with magnetic, thermal and electric properties provides a guidance of magnetic flux together with the direct guidance within a solid (the magnetic core). Thus, more of the magnetic flux is controlled to obtain improved characteristics.

The embedding material together with the first material helps to guide and concentrate the stray magnetic flux lines FL in the stray area STA outside the solid magnetic material.

Beside concentration of the flux lines FL, the embedding material can also help to conduct heat to an external environment. Additionally the embedding material can be used for an appropriate electrical insulation of the conducting parts of the component.

1.-30. (canceled)

31. A magnetic component comprising:
a magnetic core;
a coil having a winding wound around the magnetic core;
a main magnetic flux path within the magnetic core; and
a stray magnetic flux area outside the magnetic core,
wherein the stray magnetic flux area is at least partially embedded in or guided by a first material, and
wherein the first material is a thermally conductive filler or potting material.

32. The magnetic component according to claim 31, wherein the magnetic component is a coupled inductor with two inductive segments coupled magnetically or electromagnetically to one another.

33. The magnetic component according to claim 31, wherein the magnetic component is a coupled inductor with more than two inductive segments coupled magnetically or electromagnetically to one another.

34. The magnetic component according to claim 31, wherein the first material has a magnetic permeability μ_1 with 1.5≤μ_1≤26.

35. The magnetic component according to claim 31, wherein the magnetic core has a magnetic permeability μ_2 with 26≤μ_2≤27000.

36. The magnetic component according to claim 31, wherein the first material has a thermal conductivity equal to or larger than 0.5 W/mK.

37. The magnetic component according to claim 31, wherein the first material has an electric resistivity r with r≥10 kV/mm.

38. The magnetic component according to claim 31,
wherein the magnetic core comprises an upper magnetic core part and a lower magnetic core part and/or one or more several constituent parts, and
wherein the upper magnetic core part and the lower magnetic core part form a casing with a front opening and a rear opening.

39. The magnetic component according to claim 38, wherein the coil is mounted in the casing.

40. The magnetic component according to claim 31,
wherein the coil comprises a first terminal connection and a second terminal connection,
wherein the first and second terminal connections extend outwardly from a front side or a front opening of the component.

41. The magnetic component according to claim 31, wherein the first material is arranged around the coil and/or the magnetic core.

42. The magnetic component according to claim 31,
wherein a lower magnetic core part comprises a center column for the coil to be at least partially mounted thereon, and
wherein the center column extends upwardly from a mounting plane of the lower magnetic core part and is shifted from a center of the mounting plane to a front opening.

43. The magnetic component according to claim 31, wherein a surface of the first material is flush with a rear opening.

44. The magnetic component according to claim 31, wherein a portion of the first material projects from a rear opening.

45. The magnetic component according to claim 31, further comprising a bobbin mounted on a lower magnetic core part, wherein the coil is wound around the bobbin.

46. The magnetic component according to claim 31, wherein the bobbin comprises a plastic material.

47. The magnetic component according to claim 31, further comprising an insulating paper and/or an insulating film arranged between the coil and an upper magnetic core part.

48. The magnetic component according to claim 31, further comprising:
a thermally conductive interface material between the first material and an upper magnetic core part and/or between the first material and a lower magnetic core part,
wherein the thermally conductive interface material has a hardness equal to or smaller than a hardness of the first material, or equal to or smaller than a hardness of the upper magnetic core part, or equal to or smaller than a hardness of the lower magnetic core part.

49. The magnetic component according to claim 31, wherein the first material at least partially fills up a casing of the component from a rear opening to a front opening.

50. The magnetic component according to claim 31, wherein the first material at least partially fills up a casing from a mounting plane of a lower magnetic core part to an upper magnetic core part.

51. The magnetic component according to claim 31, wherein the magnetic core, a lower magnetic core part and/or an upper magnetic core part comprise(s) a material selected from an Fe—Si based alloy, a Fe—Ni based alloy, MnZn or an MnZn based alloy, NiZn or a NiZn based alloy.

52. The magnetic component according to claim 31, wherein the first material comprises a material selected from a thermoset phenolic resin, thermoplastic polyethylene terephthalate, (PET), polyamide (PA), polyphenylene sulfide (PPS), polyetheretherketone (PEEK), polyurethane (PUR), epoxy, or a silicon based resin.

53. The magnetic component according to claim 31, wherein a front opening and a rear opening are arranged opposite to each other in two parallel and opposite directions of an expansion stress to reduce the expansion stress acting on an upper magnetic core part and a lower magnetic core part.

54. The magnetic component according to claim 31, wherein the first material does not fully encapsulate an outer surface of an upper magnetic core part and a lower magnetic core part.

55. A magnetic component comprising:
a magnetic core;
a coil having a winding wound around the magnetic core;
a main magnetic flux path within the magnetic core; and
a stray magnetic flux area outside the magnetic core,
wherein the stray magnetic flux area is at least partially embedded in or guided by a first material,
wherein the first material is a thermally conductive filler or potting material,
wherein the magnetic core has a magnetic permeability μ_2 with 26≤μ_2≤27000,
wherein the first material has a thermal conductivity equal to or larger than 0.5 W/mK, and
wherein the first material has an electric resistivity r with r≥10 kV/mm.

56. A method for manufacturing the magnetic component according to claim 31, the method comprising:
providing a mold with a coil mounted therein;
potting the mold with a thermally conductive material to form the first material;
encapsulating at least a portion of the coil;
releasing the first material and the coil from the mold; and
combining the first material with the magnetic core.

57. The method of according to claim 56,
wherein the mold comprises a lower magnetic core part,
wherein combining the first material with the magnetic core comprises combining a lower magnetic core part with an upper magnetic core part, and
wherein the first material is arranged between the upper magnetic core part and the lower magnetic core part.

58. The method according to claim 56, further comprising:
mounting a bobbin on a lower magnetic core part;
winding the coil around the bobbin; and
encapsulating a portion of the coil on the bobbin and a lower magnetic core part by the first material.

59. The method according to claim 56,
wherein the mold comprises a lower magnetic core part and an upper magnetic core part,
wherein combining the first material with the magnetic core comprises combining a lower magnetic core part, an upper magnetic core part and the first material, and
wherein the first material is arranged between the upper magnetic core part and the lower magnetic core part.

60. The method according to claim 56, further comprising arranging a thermally conductive interface material between the coil and the first material.

61. The method according to claim 56, wherein providing the mold comprises:
providing the mold including an upper magnetic core part and a lower magnetic core part and a coil mounted in the mold,
potting the mold with a thermally conductive material to form a thermally conductive filler, and
encapsulating at least a portion of the coil.
